(19) United States
(12) Patent Application Publication
(10) Pub. No.: US 2004/0258240 A1
(43) Pub. Date: Dec. 23, 2004

(54) Cryptosystems

(76) Inventor: Mukesh K. Singh, Bangalore (IN)

Correspondence Address: TEXAS INSTRUMENTS INCORPORATED, P O BOX 655474, M/S 3999, DALLAS, TX, 75265

(21) Appl. No.: 10/836,935

(22) Filed: Apr. 30, 2004

Related U.S. Application Data
(60) Provisional application No. 60/467,407, filed on May 2, 2003.

(51) Int. Cl. H04L 9/30

(52) U.S. Cl. 380/30

(57) ABSTRACT

Public key cryptosystems derived from a public key base matrix with a public key product matrix generated as the product of private key circulant matrices with the public key base matrix. Matrix elements are taken from a commutative ring. The elements of rows of private key circulant matrices being relatively prime provides security of the trapdoor function for decryption.

### CROSS-REFERENCE TO RELATED APPLICATIONS

This application claims priority from provisional application No. 0013 60/467,407, filed May 2, 2003.

### BACKGROUND OF THE INVENTION

The present invention relates to data security and encryption, and more particularly, to public key cryptosystems and methods.

The widely-used cryptosystem Data Encryption Standard (DES) has a symmetric algorithm which uses the same key for encryption and decryption on 64-bit blocks of a message. The algorithm basically includes the steps of: apply an initial permutation of the 64-bit block; next, split of the block into left and right 32-bit blocks; combine the right block with 48 bits of the 56-bit key to get 32 new bits and exclusive OR (XOR) with the left block to form a new left block; interchange the left and right blocks to reform a 64-bit block; repeat the split-combine-XOR-interchange-reform fifteen more times; and lastly, apply an inverse of the initial permutation on the 64-bit block. The partition of a message into blocks and the communication of the key between participants lead to potential security problems. Other block-based encryption methods have the same potential problems.

Alternatively, a public key cryptosystem uses separate-but-related encryption and decryption keys: a public key and a private key. The public key is used to encrypt messages which can be decrypted using the private key; thus no communication of a key is needed. Public key cryptosystems also provide digital signatures in addition to encryption of messages: the public key is used to decrypt a digital signature which has been encrypted using the private key. However, the known public key cryptosystems are computationally intensive, and typically must partition a file into smaller blocks (e.g., smaller than the modulus in RSA) which are separately encrypted.

In fact, digital signatures on documents typically follow a two-step process: first calculate the message digest of the document file with an algorithm, such as MD5, and then encrypt the digest of the document file with the private key. To verify the signature first calculate the message digest of the (unsigned) document file; next, decrypt the encrypted digest with the public key to get the plain digest, and then compare these two digests.

Public key cryptosystems typically rely on the difficulty of factoring a large number into primes or the difficulty of computing logarithms in finite fields.

One widely-analyzed public key cryptosystem is RSA which uses two large primes, p,q, to define a (public) modulus, n=pq, and a (public) encryption key, e=any random number relatively prime to (p-1)(q-1), together with a private key, d such that de=1 mod((p-1)(q-1)). The encryption of message m is m^{e} mod(n), and decryption follows from m=(m^{e})^{d} mod(n). This decryption reflects Euler's extension of Fermat's little theorem which states y^{φ(x)}=1 mod (x) for any integers x and y greater than 1 where φ(.) is Euler's phi function. Because n is a product of primes, φ(n)=(p-1)(q-1); and the existence of d such that de=1 mod(φ(n)) derives from e and φ(n) being relatively prime. Note that x and y being relatively prime means that the greatest common divisor of x and y is 1, and this is written gcd(x,y)=1.

One computational problem with RSA is that the message m expressed as a positive integer must be smaller than the modulus n. Thus typically large messages are partitioned into blocks of size less than n, and each block is separately encrypted. As with block-based symmetric key systems, this lessens security. In practice, RSA is only used for key management (encrypt keys for a session of a computationally-faster symmetric key system) or digital signatures.

However, these public key encryption methods have limited use due to excessive overhead in terms of processor time utilization.

### SUMMARY OF THE INVENTION

The present invention provides a public key cryptosystems based on circulant matrices over a commutative ring

### BRIEF DESCRIPTION OF THE DRAWINGS

FIG. 1 shows a preferred embodiment cryptosystem construction.

FIGS. 2a-2b are flow diagrams for encryption and decryption preferred embodiments.

### DESCRIPTION OF THE PREFERRED EMBODIMENTS

1. Overview

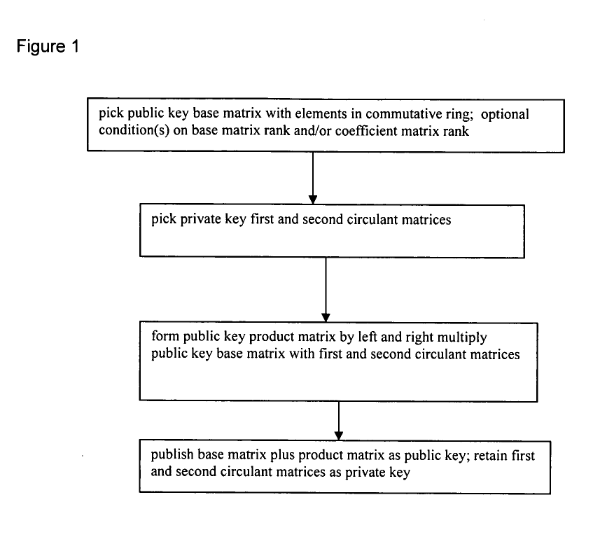

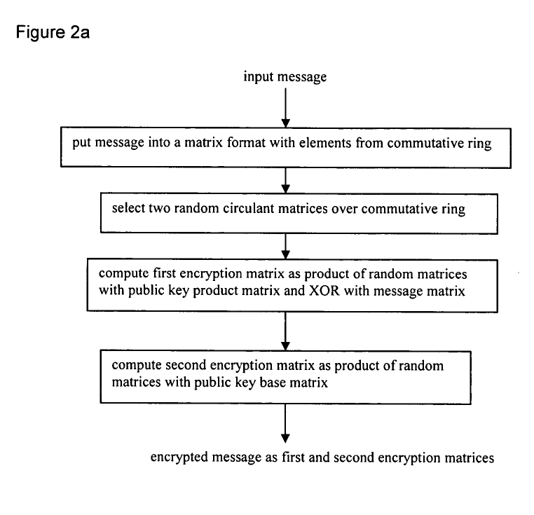

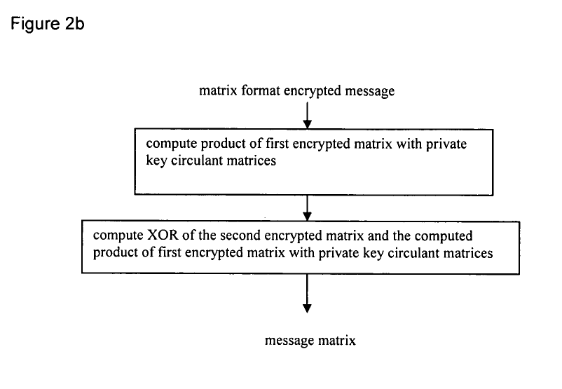

Preferred embodiment public key cryptosystems are based on matrix multiplications over a commutative ring. The public key for encryption consists of two matrices, P and G, and the encryption method for a message matrix, S, first selects two random prime circulant matrices, X and Y, and then computes the encrypted message as the two matrices C₁=XPY\hat{ }S and C₂=XGY where \hat{ } denotes exclusive OR (XOR) on an element-by-element matrix basis and bit-by-bit within the elements expressed in binary; see FIG. 2a. The private key consists of two prime circulant matrices, A and B, which were used to form the public key product matrix P from G as P=AGB; G is nonsingular (maximal rank) and commutes only with scalar multiples of the identity matrix. FIG. 1 illustrates the key construction.

Decryption relies on the commutativity of matrix multiplication of circulant matrices over a commutative ring. In particular, with public key P and G plus the received encrypted message matrices C₁ and C₂, recover S as follows:

$$\begin{matrix}A {C}_{2} B \hat{} {C}_{1} = A X G Y B \hat{} X P Y \hat{} S \\ = A X G Y B \hat{} X A G B Y \hat{} S \\ = A X G Y B \hat{} A X G Y B \hat{} S \\ = 0 \hat{} S \\ = S\end{matrix}$$

where the commutativity of the matrix multiplications of circulant matrices AX and YB was used together with the triviality of an XOR of an item with itself; see FIG. 2b.

The preferred embodiment methods provide one-way trapdoor functions which map a data matrix plus two random prime circulant matrices over a commutative ring into two message matrices. The security is based on the difficulty of solving a system of multivariate polynomial equations over a specified commutative ring. The conditions that the matrices A, B, X, and Y be prime and that matrix G be nonsingular (maximal rank) and commute only with scalars are conditions relating to the security of the trapdoor function (discussed in section 6 below). Relaxing one or more of these conditions may still yield a viable cryptosystem.

Preferred embodiment hardware could each include one or more digital signal processors (DSPs) and/or other programmable devices with stored programs for performance of the processing of the preferred embodiment methods. Alternatively, specialized circuitry (ASICs) could be used. The hardware may also contain analog integrated circuits for amplification of inputs to or outputs from networks, wireline and wireless, and conversion between analog and digital; and these analog and processor circuits may be integrated on a single die. The stored programs may, for example, be in ROM or flash EEPROM integrated with the processor or external. Exemplary DSP cores could be in the TMS320C6xxx family from Texas Instruments.

2. Circulant Matrix Background

To illustrate a preferred embodiment circulant-matrix-based public key cryptosystem, first consider the following background.

An N×N matrix whose rows are composed of cyclically shifted versions of a length-N list L is called a circulant matrix. For example, the 3×3 circulant matrix from the list L={a,b,c} is denoted circ(a,b,c) and given by:

$$circ ( a , b , c ) = [ \begin{matrix}a & b & c \\ c & a & b \\ b & c & a\end{matrix} ]$$

The list L may be of any type of elements, but the preferred embodiment methods will use elements from a commutative ring, [symbol] , such as the integers, the integers modulo a prime, the integers modulo a composite, and so forth.

The preferred embodiment methods take advantage of the closure and commutativity of matrix multiplication for circulant matrices. In particular, consider the matrix product circ(a₀, a₁, . . . , a_{N-1}) circ(b₀, b₁, . . . , b_{N-1}). With the subscripts treated modulo N, direct multiplication shows the row m, column n element of the product is Σ_{0≦k≦N-1} aₖb₋ₘ₊ₙ₋ₖ. Now simultaneously incrementing both m and n leaves each product in the summation unchanged; and thus the product is also a circulant matrix. Further, the summation is invariant under the interchange of a and b because the summation is over all products where the sum of the subscripts equals −m+n modulo N, and this, combined with the ring multiplication being commutative (aₖb₋ₘ₊ₙ₋ₖ=b₋ₘ₊ₙ₋ₖaₖ), implies the matrix multiplication is commutative for circulant matrices. Note that the summation has the form of a circular convolution.

An N×N circulant matrix with elements in commutative ring [symbol] is called prime if the elements of a row (i.e., the elements of the list generating the circulant matrix) have a greatest common divisor (gcd) in the ring equal to 1 (the multiplicative identity of [symbol] ); or if [symbol] does not have a multiplicative identity, then the gcd of the elements of a row is not an element of [symbol] . The definition of prime circulant matrix extends to various classes of commutative rings. The pertinent examples: if [symbol] is the ring of integers, then the elements of the list are relatively prime; if [symbol] is a ring (field) of integers modulo a prime, then the elements of the list are all different; if [symbol] is a ring of integers modulo a composite, then the elements of the list are all different; and if [symbol] is a Boolean ring, then there is no constraint and all circlant matrices are prime.

For a given (not necessarily square) matrix G with elements in [symbol] , define the coefficient matrix G_{c} as a doubly circulant matrix as follows. First, let R1, R2, . . . , RN denote the rows of G; next, set M_{R1}=circ(R1), M_{R2}=circ(R2), . . . , M_{RN}=circ(RN); and then define G_{c} as circ(M_{R1}, M_{R2}, . . . , M_{RN}). Thus when G is an N×M matrix, G_{c} is an NM×NM square matrix. For example, with

$$G = [ \begin{matrix}g 1 & g 2 & g 3 \\ g 4 & g 5 & g 6 \\ g 7 & g 8 & g 9\end{matrix} ] ,$$

first, the rows are: R1=[g1, g2, g3], R2=[g4, g5, g6], and R3=[g7, g8, g9]; next,

$${M}_{R1} = [ \begin{matrix}g 1 & g 2 & g 3 \\ g 3 & g 1 & g 2 \\ g 2 & g 3 & g 1\end{matrix} ] , {M}_{R2} = [ \begin{matrix}g 4 & g 5 & g 6 \\ g 6 & g 4 & g 5 \\ g 5 & g 6 & g 4\end{matrix} ] , \\ {M}_{R3} = [ \begin{matrix}g 7 & g 8 & g 9 \\ g 9 & g 7 & g 8 \\ g 8 & g 9 & g 7\end{matrix} ] ;$$

and finally:

$${G}_{c} = [ \begin{matrix}g 1 & g 2 & g 3 & g 4 & g 5 & g 6 & g 7 & g 8 & g 9 \\ g 3 & g 1 & g 2 & g 6 & g 4 & g 5 & g 9 & g 7 & g 8 \\ g 2 & g 3 & g 1 & g 5 & g 6 & g 4 & g 8 & g 9 & g 7 \\ g 7 & g 8 & g 9 & g 1 & g 2 & g 3 & g 4 & g 5 & g 6 \\ g 9 & g 7 & g 8 & g 3 & g 1 & g 2 & g 6 & g 4 & g 5 \\ g 8 & g 9 & g 7 & g 2 & g 3 & g 1 & g 5 & g 6 & g 4 \\ g 4 & g 5 & g 6 & g 7 & g 8 & g 9 & g 1 & g 2 & g 3 \\ g 6 & g 4 & g 5 & g 9 & g 7 & g 8 & g 3 & g 1 & g 2 \\ g 5 & g 6 & g 4 & g 8 & g 9 & g 7 & g 2 & g 3 & g 1\end{matrix} ]$$

Note that when considered as a 9×9 matrix with elements gk, G_{c} is not circulant.

3. Circulant Matrix-Based One-Way Trapdoor Function

The preferred embodiment encryption methods use a one-way trapdoor function that maps N×M base matrix G to N×M product matrix P=AGB where the matrix elements are elements of a commutative ring [symbol] . Given G and P, it is difficult to recover A and B when the following conditions apply: (i) G is a non-singular matrix (has maximal rank) and commutes only with itself and with scalars (i.e., diagonal matrices with the diagonal element an element of the ring) and (ii) A is N×N and B is M×M and both are prime circulant matrices with elements in [symbol] .

This trapdoor function is unusual in the sense that there are always (m+1) sets of matrices (A′, B′) which will satisfy P=A′GB′ where m is the number of invertible elements of [symbol] , not counting the identity. In particular, if P=AGB and A′=Ax plus B′=Bx⁻¹ where x is an invertible element of [symbol] . (Ax indicates multiplication of each element of A by x which is equivalent to matrix multiplication by a diagonal matrix with all diagonal elements equal to x), then A′GB′=AxG Bx⁻¹=AxGx⁻¹B=AGx x⁻¹B=AGB=P.

The converse is also true: if A′GB′=AGB, then there exists an invertible element, x, such that A′=Ax and B′=Bx⁻¹. This uniqueness of A and B up to multiplication by invertible elements (units) follows from the properties of G, A, and B. Explicitly, presume A′GB′=AGB and left and right multiply by the inverse matrices A⁻¹ and B⁻¹ to have G=A⁻¹A′GB′B⁻¹. But G only commutes with scalars, so A⁻¹A′ and B′B⁻¹ are both scalars (i.e., diagonal matrices with the diagonal matrix elements all equal to an element of the ring); so without loss of generality take A⁻¹A′=x and B′B⁻¹=y. Hence, G=x G y. But scalars commute with G and G is non-singular (has maximal rank) which allows cancellation, so the scalars must be inverses: y=x⁻¹. That is, A′=Ax and B′=Bx⁻¹.

Some examples: First, when the commutative ring is the set of integers with the usual operations, there are only two invertible elements, 1 and −1, and thus there will be two solutions: (A, B) and (−A, −B).

Next, when the commutative ring is the set of integers modulo a prime, p, the ring is Galois field, GF(p), and all non-zero elements are invertible and there will be p-1 solutions. Thus the problem to find (A, B) will reduce to one variable less than the number of variables actually used to formulate A and B; namely, 2N−1. Indeed, let A=circ(a1, a2, . . . ,aN), B=circ(b1, b2, . . . , bN), A′=circ(a1′, a2′, . . . ,aN′), and B′=circ(b1′, b2′, . . . , bN′). Now presume the a1, a2, . . . , aN and b1, b2, . . . , bN are fixed. Next, without loss of generality assign an arbitrary value λ to a1′, then A′=Ax implies a1′=λ=a1 x and thus x=λa1⁻¹. Hence, a2′=a2 x=a2λa1⁻¹, a3′=a3x=a3λa1⁻¹, . . . , aN′=aN x=aN λa1⁻¹, and similarly: b1′=b1 x⁻¹=b1λ⁻¹ a1, b2′=b2x⁻¹=b2λ⁻¹a1, . . . , bN′=bNx⁻¹=bNλ⁻¹a1. Hence, the number of variables is the same.

Lastly, when the commutative ring is the set of integers modulo a composite, n, the number of non-zero invertible elements equals φ(n) where φ(.) is Euler's phi function.

4. Circulant Matrix-Based Key Agreement

The key agreement between two parties is as follows, and can be extended to more than two parties. Begin with public N×M matrix G, which has elements from commutative ring [symbol] . Initially, Party1 selects secret N×N matrix A₁ and secret M×M matrix B₁, which are circulant with elements in commutative ring [symbol] , and then computes P₁=A₁GB₁ and sends (G, P₁) to Party2. Party2 gets (G, P₁) and selects secret N×N matrix A₂ and secret M×M matrix B₂, which are circulant with elements in commutative ring [symbol] , and then computes P₂=A₂ G B₂ and sends (G, P₂) to Party1. Then Party1 computes S=A₁P₂B₁ and Party2 computes S=A₂P₁B₂; S is the shared secret for encryption. Note that the commutativity of matrix multiplication of circulant matrices allowed the two different computations to give the same S.

5. Circulant Matrix-Based Public Key Cryptosystems

Preferred embodiment encryption and decryption use the foregoing circulant matrix-based processing as follows. Presume an N×M base matrix G with matrix elements in a commutative ring [symbol] , G may satisfy conditions such as be nonsingular (have maximal rank) and have limited commutation and generate a coefficient matrix not of maximal rank.

Party1 creates a public key with the following steps: (1) select secret N×N matrix A and secret M×M matrix B, where both A and B are circulant matrices with elements in the commutative ring [symbol] , and both may be prime circulant matrices (see section 6); (2) compute P=AGB; and (3) publish (G, P) with [symbol] implicit as a public key for encryption; the private key consists of the two secret circulant matrices (A, B).

Party2 can encrypt a message for Party1 by the steps of: (1) format the plaintext message as an N×M matrix, S, with elements in the commutative ring [symbol] where the ring elements are represented in binary; (2) select random N×N matrix X and random M×M matrix Y, where both X and Y are circulant matrices with elements in the commutative ring [symbol] , and (3) compute the encrypted message as the two N×M matrices C₁=XPY\hat{ }S and C₂=XGY where \hat{ } denotes exclusive OR (XOR) computed element-by-element in the matrices and bit-by-bit within each matrix element which is a ring element represented in binary. Note that the XOR is computed after the matrix multiplications.

Party1 decrypts the encrypted message by the steps: (1) multiply the received encrypted message matrix C₂ with the private key matrices A and B, and then (2) perform exclusive OR of the product with received encrypted matrix C₁ to recover S:

$$\begin{matrix}A {C}_{2} B \hat{} {C}_{1} = A X G Y B \hat{} X P Y \hat{} S \\ = A X G Y B \hat{} X A G B Y \hat{} S \\ = A X G Y B \hat{} A X G Y B \hat{} S \\ = 0 \hat{} S \\ = S\end{matrix}$$

where the commutativity of the circulant matrix multiplications AX and YB was used together with the triviality of the XOR of an item with itself.

This preferred embodiment encryption/decryption method can be illustrated with the following simple example. Take the commutative ring to be the integers modulo 35; 35=5*7 is a composite integer. Take

$$G = [ \begin{matrix}7 & 2 \\ 23 & 3\end{matrix} ] ;$$

note that G is nonsingular but that the 4×4 coefficient matrix generated by G, G_{c}, has determinant equal to 0; this helps security as described in the following section 6.

For the Party1 private key matrices take

$${A}_{1} = [ \begin{matrix}13 & 11 \\ 11 & 13\end{matrix} ] and {B}_{1} = [ \begin{matrix}15 & 17 \\ 17 & 15\end{matrix} ] ,$$

and for Party2 take

$${A}_{2} = [ \begin{matrix}11 & 2 \\ 2 & 11\end{matrix} ] and {B}_{2} = [ \begin{matrix}2 & 3 \\ 3 & 2\end{matrix} ] .$$

Party1 computes

$${P}_{1} = {A}_{1} G {B}_{1} = [ \begin{matrix}3 & 13 \\ 27 & 27\end{matrix} ]$$

and Party2 computes

$${P}_{2} = {A}_{2} {GB}_{2} = [ \begin{matrix}15 & 5 \\ 15 & 0\end{matrix} ] .$$

(P₁, G) and (P₂, G) are the published public keys for Party1 and Party2, respectively. Note that this G commutes with scalars and with

$$[ \begin{matrix}4 & 2 \\ 23 & 0\end{matrix} ] ,$$

but not with any of A₁, B₁, A₂, and B₂.

Party1 computes S₁=A₁P₂B₁ and Party2 computes S₂=A₂P₁B₂; both S₁ and S₂ are equal to

$$[ \begin{matrix}10 & 30 \\ 10 & 20\end{matrix} ] ,$$

and this is the shared secret.

A third party encrypts a message (in 2×2 matrix S format) for Party1 by first select random 2×2 circulant matrices,

$$X = [ \begin{matrix}17 & 2 \\ 2 & 17\end{matrix} ] and Y = [ \begin{matrix}3 & 2 \\ 2 & 3\end{matrix} ] ;$$

then compute C₁=XP₁Y\hat{ }S and C₂=XGY. Let

$$S = [ \begin{matrix}25 & 28 \\ 28 & 5\end{matrix} ] ,$$

so:

$${C}_{1} = [ \begin{matrix}25 & 20 \\ 20 & 5\end{matrix} ] ⋀ [ \begin{matrix}25 & 28 \\ 28 & 5\end{matrix} ] = [ \begin{matrix}0 & 8 \\ 8 & 0\end{matrix} ] and {C}_{2} = [ \begin{matrix}15 & 30 \\ 30 & 30\end{matrix} ] .$$

Then the third party sends (C₁, C₂) to Party1 as the encryption of message S.

Party1 decrypts by computing:

$$\begin{matrix}{A}_{1} {C}_{2} {B}_{1} ⋀ {C}_{1} = [ \begin{matrix}13 & 11 \\ 11 & 13\end{matrix} ] [ \begin{matrix}15 & 30 \\ 30 & 30\end{matrix} ] [ \begin{matrix}15 & 17 \\ 17 & 15\end{matrix} ] ⋀ [ \begin{matrix}0 & 8 \\ 8 & 0\end{matrix} ] \\ = [ \begin{matrix}25 & 20 \\ 20 & 5\end{matrix} ] ⋀ [ \begin{matrix}0 & 8 \\ 8 & 0\end{matrix} ] \\ = [ \begin{matrix}25 & 28 \\ 28 & 5\end{matrix} ]\end{matrix}$$

which recovers S. Note that the bit-by-bit XOR of 20 and 8 is the XOR of 10100 and 01000 which equals 11100=28.

6. Security

This section discusses the security of the preferred embodiment trapdoor function for various commutative rings and matrix conditions.

(a) The Ring GF(p)

The commutative ring of integers modulo a (large) prime, p, is the finite (Galois) field GF(p), and all non-zero elements have inverses (are units) and thus divide every other element.

The security of many recently proposed cryptosystems is based on the difficulty of solving a system of quadratic multivariate polynomial equations which is NP-hard over any field. There are quite a few algorithms for solving a system of multivariate polynomial equations modulo a large prime, including the Grobner bases technique and the homotopy method. However, all of these algorithms have very large exponential complexity in the number of variables. Thus, the preferred embodiments select an N×M base matrix G whose rows are elements of GF(p) in such a way that the NM×NM coefficient matrix, G_{c}, derived from G has rank NM−min(N,M)+1. This implies any attack based on Gauss reduction of the coefficient matrix would not work.

For example, analyze the 3×3 problem as follows. Let A=circ(a,b,c) and B=circ(d,e,f) and take 3×G so such that 9×9 G_{c} has rank 3² −3+1=7. Then the product matrix P=AGB is expressed as:

$$[ \begin{matrix}p11 & p12 & p13 \\ p21 & p22 & p23 \\ p31 & p32 & p33\end{matrix} ] = [ \begin{matrix}a & b & c \\ c & a & b \\ b & c & a\end{matrix} ] [ \begin{matrix}g11 & g12 & g13 \\ g21 & g22 & g23 \\ g31 & g32 & g33\end{matrix} ] [ \begin{matrix}d & e & f \\ f & d & e \\ e & f & d\end{matrix} ]$$

Now rewrite this matrix equation in the following form. Define F(A,B)=AGB−P, so the equation is F(A,B)=0 where 0 is the 3×3 null matrix. Now the matrix elements of F depend bilinearly upon the six variables defining A and B as follows. First, label the matrix elements as:

$$F ( A , B ) = [ \begin{matrix}F1 & F2 & F3 \\ F4 & F5 & F6 \\ F7 & F8 & F9\end{matrix} ]$$

$$so \text{:}$$

$$F1 ( a , b , c , d , e , f ) = ( a * g11 + b * g21 + c * g31 ) * d + ( a * g12 + b * g22 + c * g32 ) * f + ( a * g13 + b * g23 + c * g33 ) * e - p11$$

$$F2 ( a , b , c , d , e , f ) = ( a * g11 + b * g21 + c * g31 ) * e + ( a * g12 + b * g22 + c * g32 ) * d + ( a * g13 + b * g23 + c * g33 ) * f - p12$$

$$F3 ( a , b , c , d , e , f ) = ( a * g11 + b * g21 + c * g31 ) * f + ( a * g12 + b * g22 + c * g32 ) * e + ( a * g13 + b * g23 + c * g33 ) * d - p13$$

$$F4 ( a , b , c , d , e , f ) = ( c * g11 + a * g21 + b * g31 ) * d + ( c * g12 + a * g22 + b * g32 ) * f + ( c * g13 + a * g23 + b * g33 ) * e - p21$$

$$F5 ( a , b , c , d , e , f ) = ( c * g11 + a * g21 + b * g31 ) * e + ( c * g12 + a * g22 + b * g32 ) * d + ( c * g13 + a * g23 + b * g33 ) * f - p22$$

$$F6 ( a , b , c , d , e , f ) = ( c * g11 + a * g21 + b * g31 ) * f + ( c * g12 + a * g22 + b * g32 ) * e + ( c * g13 + a * g23 + b * g33 ) * d - p23$$

$$F7 ( a , b , c , d , e , f ) = ( b * g11 + c * g21 + a * g31 ) * d + ( b * g12 + c * g22 + a * g32 ) * f + ( b * g13 + c * g23 + a * g33 ) * f - p31$$

$$F8 ( a , b , c , d , e , f ) = ( b * g11 + c * g21 + a * g31 ) * e + ( b * g12 + c * g22 + a * g32 ) * d + ( b * g13 + c * g23 + a * g33 ) * f - p32$$

$$F9 ( a , b , c , d , e , f ) = ( b * g11 + c * g21 + a * g31 ) * f + ( b * g12 + c * g22 + a * g32 ) * e + ( b * g13 + c * g23 + a * g33 ) * d - p33$$

where * denotes multiplication in GF(p).

Each of the 9 equations Fj(a,b,c,d,e,f)=0 has (p-1)⁵ solutions out of which (p-1) will satisfy F(A,B)=0. As shown in the foregoing, one variable can be assigned an arbitrary value. Thus presume a is constant in the 9 equations, then each equation will have (p-1)⁴ solutions out of which one will satisfy F(A,B)=0. So in practice a cryptanalyst cannot resort to an exhaustive search. A and B prime avoids degenerate cases.

The foregoing system of 9 equations can be simplified to another system of equations in three variables by applying Cramer's rule because the foregoing is linear in d,e,f. Thus separately solve for d,e,f from each of the three sets of equations {F1=0, F2=0, F3=0}, {F4=0, F5=0, F6=0}, and {F7=0, F8=0, F9=0}. This gives three solutions for each of d,e,f (in terms of a,b,c), and then equate the three solutions for each of d,e,f and solve them by assigning a an arbitrary value. To solve this reduced system requires solving the non-linear equation in two variables, b,c, of degree three that will have only one solution as shown above. G was taken such that G_{c} is of rank 7, thus solving by Gauss Reduction would require that 9−7=2 variables be taken arbitrarily. But the system reduces to only two variables, b,c; thus using Gauss Reduction does not give any advantage.

Gauss-Reduction could be applied on the system. After rearranging the system of equations becomes:

$$[ \begin{matrix}F1 \\ F2 \\ F3 \\ F4 \\ F5 \\ F6 \\ F7 \\ F8 \\ F9\end{matrix} ] = [ \begin{matrix}g11 & g12 & g13 & g21 & g22 & g23 & g31 & g32 & g33 \\ g13 & g11 & g12 & g23 & g21 & g22 & g33 & g31 & g32 \\ g12 & g13 & g11 & g22 & g23 & g21 & g32 & g33 & g31 \\ g31 & g32 & g33 & g11 & g12 & g13 & g21 & g22 & g23 \\ g33 & g31 & g32 & g13 & g11 & g12 & g23 & g21 & g22 \\ g32 & g33 & g31 & g12 & g13 & g11 & g22 & g23 & g21 \\ g21 & g22 & g23 & g31 & g32 & g33 & g11 & g12 & g13 \\ g23 & g21 & g22 & g33 & g31 & g32 & g13 & g11 & g12 \\ g22 & g23 & g21 & g32 & g33 & g31 & g12 & g13 & g11\end{matrix} ] [ \begin{matrix}a * d \\ a * f \\ a * e \\ b * d \\ b * f \\ b * e \\ c * d \\ c * f \\ c * e\end{matrix} ] - \\ [ \begin{matrix}p11 \\ p13 \\ p12 \\ p31 \\ p33 \\ p32 \\ p21 \\ p23 \\ p22\end{matrix} ] = 0$$

where again * denotes multiplication in GF(p).

Thus the 9 variables a*d, a*f, a*e, b*d, b*f, . . . can be solved uniquely by Gauss-Reduction if the coefficient matrix is non-singular. But the coefficient matrix is just G_{c}, and G was taken so that G_{c} is singular with rank 7 (=NM−min(N,M)+1), and thus Gauss-Reduction does not work.

Hence, for an N×N matrix the quadratic system will reduce to a system of equations in N−1 variables of degree N. But for large N, finding the base matrix G such that the coefficient matrix G_{c} is of rank NM−min(N,M)+1 is not easy. But if the prime p is on the order of 64 bits, then taking the base matrix G such that the coefficient matrix G_{c} is of rank NM−2 is not difficult because this only requires solution of a system of equations in two variables which can be solved by any of the known methods. Since in this case the security is on the order of 2¹²⁸ trials (because two variables are arbitrary) against solution by Gauss Reduction, the rank NM−min(N,M)+1 criterion need not be satisfied. But for smaller primes the rank NM−min(N,M)+1 criterion needs to be approached. To address current security requirements, the matrix dimension should be at least 8×8 with 64-bit primes and rank G_{c}=64−2=62. Since the system of quadratic equations will have 15 variables, the Grobner bases technique or the homotopy method will require complexity of the order of more than 2¹²⁸ ring operations.

(b) The Ring Zₙ with n=pq

The commutative ring of integers modulo a large composite, n=pq, with p and q primes, is denoted Zₙ; note that Zₙ has zero divisors, e.g., p*q=0.

The security of many current cryptosystems, including RSA, is based on the difficulty of factoring a large composite integer into its component primes. This problem has been assumed to be hard for some time in the cryptographic literature. A preferred embodiment cryptosystem selects an N×M base matrix, G, whose rows are elements of Zₙ and such that the corresponding NM×NM coefficient matrix, G_{c}, has a determinant equal to 0 (in Zₙ). Thus any attack based on Gaussian reduction of the coefficient matrix would not work and because n is so large that taking one variable arbitrary would not be practical. Except for the case of a 2×2 base matrix, every dimension from 3×2 and higher for the base matrix is secure. For the case of a 2×2 base matrix Pollard's heuristic can solve the underlying quadratic equations.

Consider the analysis of a 3×2 base matrix explicitly: Take

$$G = [ \begin{matrix}g1 & g2 \\ g3 & g4 \\ g5 & g6\end{matrix} ]$$

with rank 2 such that

$${G}_{c} = [ \begin{matrix}g1 & g2 & g3 & g4 & g5 & g6 \\ g2 & g1 & g4 & g3 & g6 & g5 \\ g5 & g6 & g1 & g2 & g3 & g4 \\ g6 & g5 & g2 & g1 & g4 & g3 \\ g3 & g4 & g5 & g6 & g1 & g2 \\ g4 & g3 & g6 & g5 & g2 & g1\end{matrix} ]$$

has a determinant equal to 0 (modulo n). Then for

$$A = [ \begin{matrix}a & b & c \\ c & a & b \\ b & c & a\end{matrix} ] and B = [ \begin{matrix}d & e \\ e & d\end{matrix} ] ,$$

calculate

$$P = [ \begin{matrix}p1 & p2 \\ p3 & p4 \\ p5 & p6\end{matrix} ] = [ \begin{matrix}a & b & c \\ c & a & b \\ b & c & a\end{matrix} ] [ \begin{matrix}g1 & g2 \\ g3 & g4 \\ g5 & g6\end{matrix} ] [ \begin{matrix}d & e \\ e & d\end{matrix} ]$$

where the multiplications and additions are all modulo n.

It is difficult to find A and B given n, G, and P. Solving this problem is as difficult as factoring n. Using Cramer's rule reduces this system of six (actually five linearly independent) quadratic equations in five variables to either a system of four polynomial equations of degree two in three variables or a system of three polynomial equations of degree three in two variables, depending upon which set of variables (either (a,b,c) or (d,e)) are used. This G dimension 3×2 leads to systems sufficiently difficult to solve to withstand present day security requirements (A. Shamir, On the Generation of Multivariate Polynomials which are Hard to Factor, Proceedings of the 25^{th} annual ACM Symposium of Theory of Computing (San Diego 1993) has a general discussion). Further, the 3×2 base matrix preferred embodiment only requires 36 multiplications and is much faster than those cryptosystems based on exponentiation. But the size of the preferred embodiment public key is six (five if the linear dependence of p1, p2, . . . , p6 is also published) times those based on exponentiation. This is a tradeoff with the preferred embodiment over Zₙ.

(c) The Ring of Integers Z

The ring of integers, Z, is an integral domain with only 1 and −1 as invertible elements. The same analysis as in the foregoing subsections applies: the matrix equations to find A and B given G and P are NP-hard and Cramer's rule converts the problem into solving a system of multivariate polynomial equations with the coefficient matrix G_{c}. There are quite a few algorithms for solving over the ring of integers including the Grobner bases technique. All of these algorithms have very large exponential complexity in the number of variables. One advantage of taking the preferred embodiment ring to be the integers is in the public key encryption where the size of the encrypted data will be only approximately 1.5 times the plaintext size instead of 2 times the plaintext as in the foregoing two subsections, if the size of the base matrix elements is small. Since 1 and −1 are the only invertible elements, G need not be taken so that the determinant of G_{c} equals 0 if the elements of G are large. To solve the system through Gaussian Reduction one needs to try all of the factors.

(d) The Ring is Boolean

The set of integers, expressed in binary, with the addition operation as XOR bit-by-bit and the multiplication operation as AND bit-by-bit form a Boolean ring with the additive identity having all 0 bits and the multiplicative identity having all 1 bits. The preferred embodiment trapdoor function again analyzes as in the foregoing subsections, but there is insufficient analysis of the Boolean ring to assess security currently.

7. Modifications

The preferred embodiments may be varied while retaining the feature of a cryptosystem generated from a base matrix plus two circulant matrices with matrix elements from a commutative ring.

For example, various conditions on the matrices can be imposed to help security of the cryptosystem; including conditions on the rank of the base matrix and its coefficient matrix, and so forth. The relaxation of non-commutative criteria of private key with the base matrix will make the system insecure.

What is claimed is:

1. A method of public key encryption, comprising:
(a) providing circulant matrices X and Y; and
(b) computing matrices C₁=XPY\hat{ }S and C₂=XGY, where S is a matrix of information to be encrypted, \hat{ } denotes exclusive OR, and matrices G and P form a public key;
(c) wherein the matrices C₁ and C₂ are an encryption of S.

2. The method of claim 1, wherein:
(a) the elements of the matrices X, P, Y, G, and S are integers.

3. The method of claim 2, wherein:
(a) the elements of each row of matrix X have a greatest common divisor equal to 1; and
(b) the elements of each row of matrix Y have a greatest common divisor equal to 1.

4. The method of claim 1, wherein:
(a) the elements of the matrices X, P, Y, G, and S are integers modulo a prime.

5. The method of claim 4, wherein:
(a) the elements of each row of matrix X are all different; and
(b) the elements of each row of matrix Y are all different.

6. The method of claim 1, wherein:
(a) the elements of the matrices X, P, Y, G, and S are integers modulo a composite.

7. The method of claim 6, wherein:
(a) the elements of each row of matrix X are all different; and
(b) the elements of each row of matrix Y are all different.

8. The method of claim 1, wherein:
(a) the elements of the matrices X, P, Y, G, and S are Boolean.

9. A public key, comprising:
(a) matrices P and G, where P=AGB with matrices A and B being circulant;
(c) whereby the matrices C₁ and C₂ are an encryption of S for C₁=XPY\hat{ }S and C₂=XGY, with \hat{ } denoting exclusive OR and X and Y circulant matrices.

10. The cryptosystem of claim 9, wherein:
(a) the elements of the matrices X, P, Y, G, A, B, and S are members of a commutative ring.

11. A method of public key decryption, comprising:
(a) for an input of matrices C₁ and C₂ which encrypt a matrix S, computing the matrix AC₂B\hat{ }C₁ where \hat{ } denotes exclusive OR, and matrices A and B are circulant and relate to public key matrices P and G by P=AGB with public key matrices P and G used in computation of input matrices C₁ and C₂.

12. The method of claim 11, wherein:
(a) said computation of input matrices C₁ and C₂ in step (a) of claim 11 is by selection of circulant matrices X and Y, and computation C₁=XPY\hat{ }S and C₂=XGY.

13. The method of claim 11, wherein:
(a) the elements of the matrices A, P, B, G, and S are integers.

14. The method of claim 13, wherein:
(a) the elements of each row of matrix A have a greatest common divisor equal to 1; and
(b) the elements of each row of matrix B have a greatest common divisor equal to 1.

15. The method of claim 11, wherein:
(a) the elements of the matrices A, P, B, G, and S are integers modulo a prime.

16. The method of claim 15, wherein:
(a) the elements of each row of matrix A are all different; and
(b) the elements of each row of matrix B are all different.

17. The method of claim 11, wherein:
(a) the elements of the matrices A, P, B, G, and S are integers modulo a composite.

18. The method of claim 17, wherein:
(a) the elements of each row of matrix A are all different; and
(b) the elements of each row of matrix B are all different.

19. The method of claim 11, wherein:
(a) the elements of the matrices A, P, B, G, and S are Boolean.

20. The method of claim 11, wherein:
(a) matrix G generates a singular coefficient matrix.
